(19) United States
(12) Patent Application Publication
(10) Pub. No.: US 2007/0101044 A1
(43) Pub. Date: May 3, 2007

(54) Virtually indexed cache system

(76) Inventor: Kurichiyath Sudheer, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,955

(22) Filed: Jul. 25, 2006

(30) Foreign Application Priority Data
Oct. 27, 2005 (IN) IN2873/CHE/2005

(51) Int. Cl. G06F 12/08; G06F 13/28

(52) U.S. Cl. 711/3; 711/141

(57) ABSTRACT

A method of handling multiple aliases, the method comprising: designating one of the aliases as a master alias; designating the other aliases as slave aliases; caching data associated with the master alias; storing a translation for each slave alias; handling memory accesses for the master alias by using the master alias to access the cache; and handling memory accesses for each slave alias by obtaining the stored translation and using the translation to access the cache.

### RELATED APPLICATIONS

The present application is based on, and claims priority from India Application Number IN2873/CHE/2005, filed Oct. 27, 2005, the disclosure of which is hereby incorporated by reference herein in its entirety.

### BACKGROUND OF THE INVENTION

A virtually indexed cache based system 1 is shown in FIG. 1. The system comprises a central processing unit (CPU) 2, cache 3, memory management unit (MMU) 4 and main memory 5.

For simple clarification of cache operations, we discuss below an example in which the cache 3 is a direct mapped cache. Direct mapped caches have a one to one correspondence between the cache index and cached data, whereas n-way set associate caches can have a 1 to n relationship between the cache index and cached data. For example 1 to 2 for 2-way set associate caches, 1 to 4 for 4-way set associate caches and so on.

To make cache searching faster, the cache 3 is divided into a number of lines of defined equal size. For example, for a 32 bit system with a 16 KB cache, the cache 3 can be divided into 256 lines of size 64 bytes. Such an organization can be compared with an array of fixed size data elements. The line numbers 0 to 255 are the cache index and the size 64 bytes is the cache line size. When the CPU 2 wishes to read to or write from memory, it generates a virtual address 20 with the format illustrated in FIG. 2. The virtual address 20 is nominally divided into a page offset field 36 (bits 0 to P−1) and a Virtual Page Number (VPN) field 37 (bits P upwards). The virtual address 20 is transformed into a hashed address 20′, by a hash function 23. The hash function takes well defined bits from the CPU generated virtual address 20 to generate the hashed address 20′.

Bits 0 to K−1 of the hashed address 20′ comprise an index 21, and bits K to N comprise a tag 22. P and K may have the same value or different values. In this case the number of cache lines is 256 so K has a value of 8, and the system is a 32 bit system so N has a value of 32. Referring now to FIG. 3, the index 21 (in this example XXX) is used to look up a line 23 in the cache 3. The tag 24 of the line 23 is then compared with the tag 22 in the virtual address 20. In this case the tags match so there is a “cache hit”. Where there is a cache hit, the data (in this case 12345678) is returned directly to the CPU 9 without requiring any interaction with the main memory 5. If the tags 22 and 24 do not match, then there is a “cache miss”. In the case of cache miss, the virtual address is sent to the MMU 4 for translation.

The data structure of the MMU 4 is shown in FIG. 4. The MMU includes a Translation Lookaside Buffer (TLB) 30 and a Page Table 31. The Page Table 31 consists of a list of Page Table Entries (PTEs), each PTE comprising a virtual page number (VPN) field 34 and an associated physical page number (PPN) field 35. The TLB 30 contains a sub-set of the PTEs recorded in the Page Table 31, and is essentially a cache of the Page Table 31. That is, the TLB consists of a list of TLB entries, each comprising a virtual page number (VPN) field 32 and an associated physical page number (PPN) field 33.

The VPN of the virtual address is first compared with the VPNs stored in the TLB 30. If the TLB contains the VPN, then the associated physical address is calculated from the tuple <PPN, Page Offset 36> and this physical address is sent to the main memory 5. If the TLB does not contain the VPN, then the VPN is looked up in the Page Table 31, and the associated physical address is calculated from the tuple <PPN, Page Offset 36> and this physical address is sent to the main memory 5. On receipt of the tuple <PPN, Page Offset 36>, the main memory 5 returns the data stored at that physical address, and that data is recorded in the cache 3 so that the CPU 2 can read the data from the cache 3.

The process of ensuring that the contents of a cache location is the same as its corresponding main memory location is known as “validation”. The process of removing the mapping between a cache location (or consecutive cache locations) and the corresponding main memory location (or locations) is known as “invalidation”.

When two or more virtual addresses translate to the same location in main memory 5, the two virtual addresses are known as aliases. Aliases are used when applications need to share memory.

The following are the possible cache scenarios if aliases are used.
1. Both aliases generate the same cache index and cache tag. (Note in this case, the virtual addresses 20 are not identical, but the hashed addresses 20′ are).
2. Both aliases generate the same cache index, but a different cache tag.
3. The aliases refer to different cache indices, but the same tag.
4. The aliases refer to different cache indices and different tags.

Case 1 does not create any cache coherence issues, as both addresses will point to the same cache line.

Case 2 also creates no cache coherency issues, as illustrated by the following example. Virtual addresses VPN1 and VPN2 are aliases, as follows:

| Virtual Address | Tag | Index |
|---|---|---|
| VPN1 | AAAAAAAA | XXX |
| VPN2 | BBBBBBBBB | XXX |

The cache 3 contains a line corresponding with VPN1, as follows:

| Tag | Data | Index |
|---|---|---|
| ??? | | 0 |
| AAAAAAAA | 12345678 | XXX |
| ??? | | 255 |

If VPN2 is then used to read to or write from the memory location associated with VPN1 and VPN2, then the cache 3 will be updated as follows:

| Tag | Data | Index |
|---|---|---|
| ??? | | 0 |
| BBBBBBBB | 12345678 | XXX |
| ??? | | 255 |

Thus it can be seen that the cache line with index XXX alternates between VPN1 and VPN2. This is known as a “ping-pong” situation. This creates no cache coherency issues, but does create performance issues since only one alias can occupy cache at a time.

Case 3 and Case 4 create cache coherency problems, as demonstrated through the following example. Taking Case 3 first: virtual addresses VPN1 and VPN2 are aliases, as follows:

| Virtual Address | Tag | Index |
|---|---|---|
| VPN1 | BBBBBBBBB | AAA |
| VPN2 | BBBBBBBBB | BBB |

The cache 3 contains a line corresponding with VPN1, as follows:

| Tag | Data | Index |
|---|---|---|
| ??? | | 0 |
| AAAAAAAA | BBBBBBBB | AAA |
| ??? | | 255 |

If VPN2 is then used to access the memory location associated with VPN1 and VPN2, then the cache 3 will be updated as follows:

| Tag | Data | Index |
|---|---|---|
| ??? | | 0 |
| BBBBBBBB | 12345678 | AAA |
| BBBBBBBB | ABCDEFGH | BBB |
| ??? | | 255 |

At this point the cache contains two different entries, each associated with the same main memory location. When accessing the same memory location through VPN1, the CPU will not see any changes made through a previous access by the alias VPN2 (and vice versa). This is an example of a cache coherency problem.

Another problem that is observed on virtually indexed cache systems is that of supporting private mapping of shared memory areas and files. Generally sharing of memory between processes is done through global virtual memory. This global virtual memory is accessible through virtual addresses, which are the same for all processes. This means that all processes will use the same address to access the shared area.

Suppose one process needs to map an area of memory or file that is already mapped in the shared region. This process needs to map a whole or part of this shared area or file into its private area. This would result in a case similar to an alias. The Unix system call mmap with option MAP_PRIVATE needs alias support to provide its intended functionality. In this case, a virtually indexed cache system will run into the same cache coherency problem that is associated with aliases.

The root cause behind the cache coherency problem is that aliases can occupy two different cache lines. If this situation can be avoided, cache coherency problems can be ruled out and hence true support for aliases can be provided. One advantage of a virtually indexed cache is that it can provide data faster by avoiding address translation or overlapping caches access with address translation and have less latency than physical caches.

Operating systems written for virtually indexed caches are responsible for addressing cache coherency problems such as the one described above. One conventional approach is to perform a ping-pong operation. In a ping-pong operation, a check is first made whether a virtual address has any aliases. If so, a check is made of the cache to determine whether the cache contains a line corresponding with the alias(es). If so, then the cache entry for each one of the aliases is removed. An example of a ping-pong operation can be illustrated with reference to the example given above. A memory access using VPN1 first checks whether VPN1 has any aliases. This returns a single alias VPN2. A check is made of the cache to determine whether the cache contains a line corresponding with VPN2. The cache entry for VPN2 is then removed. Similarly, if VPN2 is accessed, then the cache entry for VPN1 is removed. This ping-pong operation ensures that only a single alias is cached (although, in contrast with Case 2, the cache line index will vary depending on the last alias that was used to access the memory location).

The ping-ping operation described above creates performance issues. As a result, the use of aliases in virtually indexed cache systems is generally restricted to situations such as Case 1 and Case 2. As the chances for Case 1 and Case 2 are very limited, conventional virtual cache systems are mediocre in terms of alias support capability.

A second conventional solution is described in EP-A-0729102, in which cache coherency issues are avoided by disabling caching when aliases are used. A CV (cachable-in-virtual-cache) entry is added to the Page Table and TLB entries so that virtual addresses that have aliases are not cached, or are cached only when they are accessed for a read operation.

This solution does not provide full support for aliases on virtually indexed cache systems.

A third conventional solution is described in “Consistency Management for virtually indexed caches” Bob Wheeler Brian N. Bershad published in Architectural Support for Programming Languages and Operating Systems, Proceedings of the fifth international conference on Architectural support for programming languages and operating systems, Boston, Mass., United States Pages: 124-136 (1992). This ACM paper describes a way to ensure cache coherency by reverse translation. Since all aliases get translated to the same physical address, the reverse translation of all aliases will point to the same physical page. A software cache table is indexed by physical page number. This table contains the cache state (dirty or clean) and the virtual address that owns the cache entry. With the help of this table it is possible to determine any coherency issues because of concurrent access via alias by invalidating or validating and invalidating of caches.

Every memory transaction (read or write or DMA) needs to go through this algorithm in order to achieve cache coherency. It needs memory management hardware support to enable exceptions to run the algorithm when simultaneous accesses through alias. The performance penalty of this approach is very heavy because of the traps generated during memory access.

### BRIEF DESCRIPTION OF THE DRAWINGS

Embodiments of the invention will now be described by way of example with reference to the accompanying drawings in which:

FIG. 1 shows a cache based computer system.

FIG. 2 shows the hashing of a virtual address.

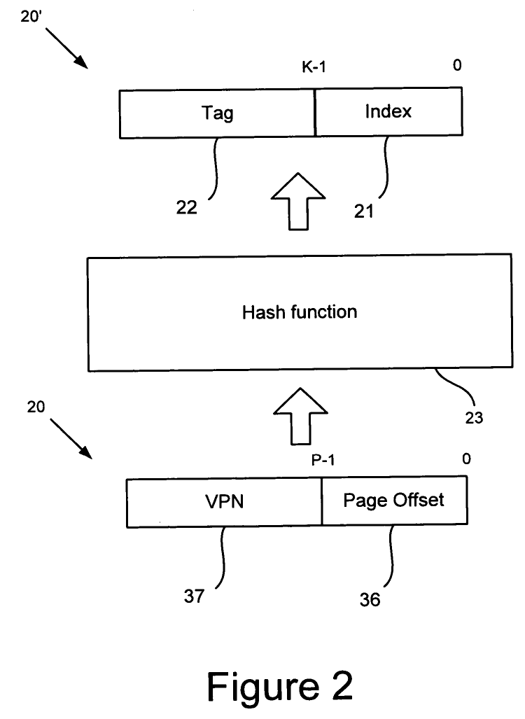

FIG. 3 shows a direct mapped cache.

FIG. 4 shows a Page Table and Translation Lookaside Buffer.

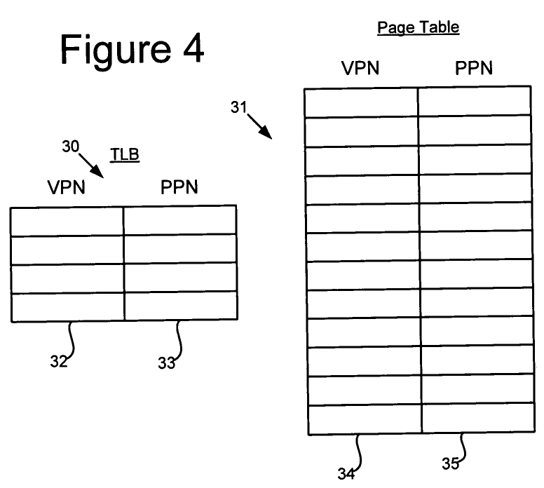

FIG. 5 is a flowchart showing a first method of updating a modified TLB/Page Table.

FIG. 6 is a flowchart showing a READ process.

FIG. 7 is a flowchart showing a second method of updating a modified TLB/Page Table.

FIG. 8 is a flowchart showing a third method of updating a modified TLB/Page Table.

### DETAILED DESCRIPTION OF AN EMBODIMENT OF THE INVENTION

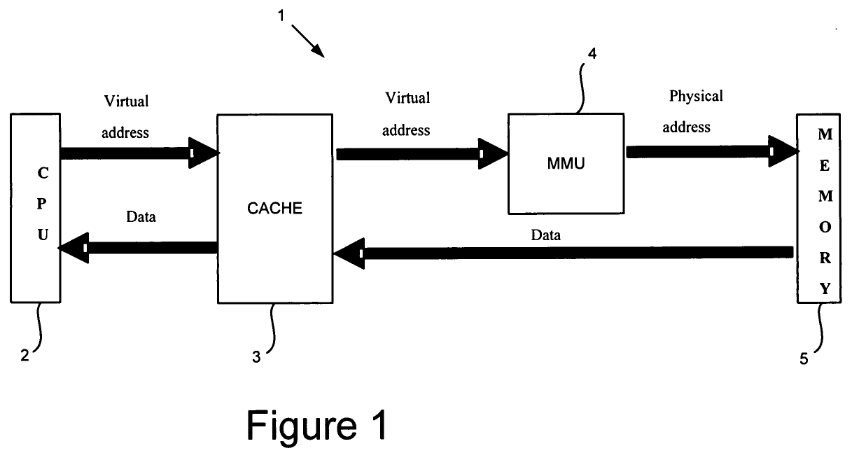

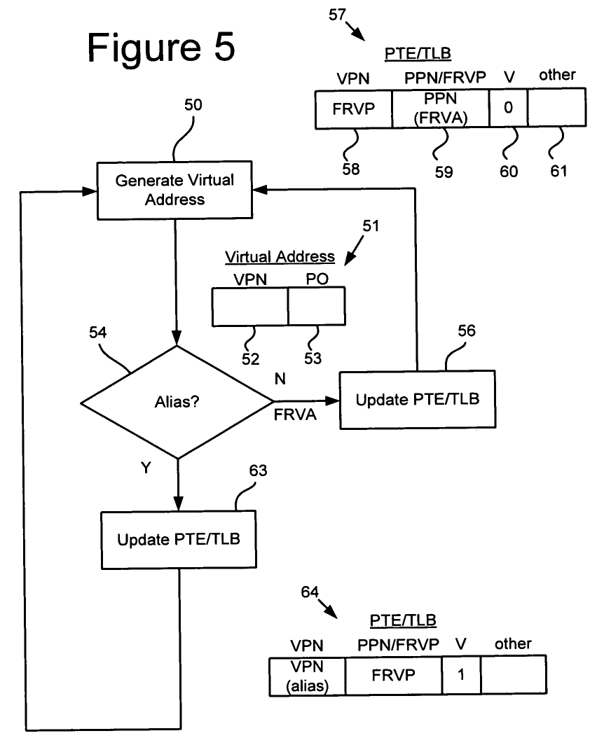

A first method constituting an embodiment of the present technique provides a modified TLB/Page Table which is updated according to the method illustrated in FIG. 5. The method of FIG. 5 may be implemented by the system 1 of FIG. 1.

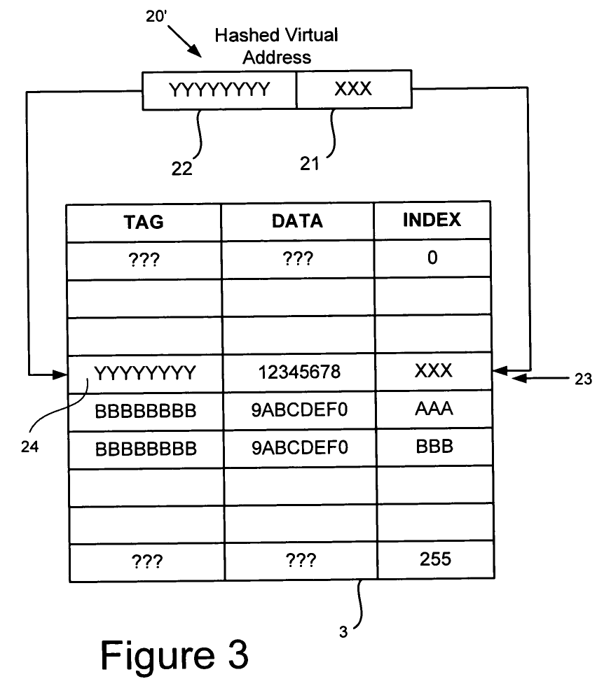

In a first step 50, a virtual address is generated by the CPU 2. The format of the virtual address is illustrated at 51, and corresponds with the format for virtual address 20 shown in FIG. 3. That is, the virtual address (VA) 51 comprises a VPN field 52 and a page offset field 53. At step 54, the CPU determines whether the virtual address is an alias. If the virtual address is not an alias, then the virtual address is designated as a master alias, which is referred to below as a First Referenced Page Address (FRVA). The Page Table and TLB are then updated at step 56. The format of a single PTE (or, equivalently, an entry in the TLB) is shown at 57, and comprises a VPN field 58, a PPN/FRVP field 59, a V bit field 60 and other bits 61. The VPN field 58 is filled with the VPN of the FRVA. This VPN is referred to as the First Referenced Virtual Page (FRVP). The V bit 60 is set to zero. The PPN/FRVP field 59 is filled with the PPN of the main memory location associated with the FRVA/FRVP, designated in FIG. 5 as PPN (FRVA).

If the virtual address is determined to be an alias at step 54, then the PTE/TLB are updated in step 63 to create an entry with the format shown at 64. In this case, the VPN field is filled with the VPN of the alias, designated in FIG. 5 as VPN (alias). The V bit is set to one. The PPN/FRVP field is filled with the FRVP of the FRVA associated with the alias.

Thus the method of FIG. 5 designates one of the aliases as a master alias (FRVA) by de-asserting the V bit in its PTE/TLB entry, and designates all other aliases as slave aliases by asserting the V bit in their respective PTE/TLB entries. As can be seen, there is no predesignated master/slave relationship between these aliases and the one which makes the first reference is treated as the FRVA. A translation (FRVP) is stored for each slave alias in the PTE/TLB. Cache operation remains unchanged for the master alias: that is, data associated with the master alias is cached, and memory accesses in respect of the master alias use the master alias to access the cache. In contrast, memory accesses for each slave alias are handled by obtaining the stored translation (FRVP) and using the translation to access the cache.

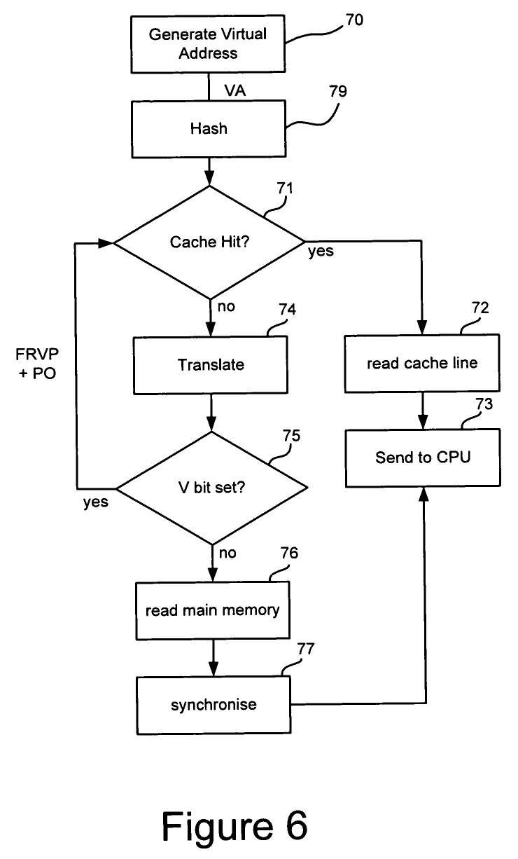

The CPU 2 and MMU 4 are configured to handle a READ process as illustrated in FIG. 6. In step 70, a Virtual Address (VA) is generated, hashed in step 79, and the hashed address is input to the cache in step 71. If there is a cache hit then the data in the cache line is read in step 72 and sent to the CPU in step 73.

If there is no cache hit, then the VA is translated by the MMU 4 in step 74. If the V bit in the PTE/TLB entry is not set (step 75), then the PTE/TLB entry must be associated with a FRVA. In this case, the PPN and Page Offset are used to access the main memory 5 in step 76. The cache is synchronized in step 77 by writing the data accessed in step 76 into the cache line associated with FRVA. The data is then sent to the CPU in step 73.

If the V bit in the PTE/TLB entry is set (step 75) then the PTE/TLB entry must be associated with an alias which is not an FRVA. Therefore in this case, the FRVP (which is stored in the PPN/FRVP field of the PTE/TLB entry), and the Page Offset (from the virtual address of the alias) are hashed in step 79, and the hashed address is input to the cache in step 71.

PTE/TLB granularity is decided by Page Size, and Cache line size is the factor that decides cache entry granularity. Therefore, there will be only one PTE/TLB entry for a set of addresses if their VPN is the same. Similarly, cache entries can be shared by a set of addresses if they are contiguous and fall within the cache line size boundary. Hence the V bit is set at page granularity as PTE/TLB works at page level.

A second method of updating the PTE/TLB is to retain the physical page number in the PTE/TLB and add an FRVP field such as shown below.

| | | | | |
|---|---|---|---|---|
| VPN | FRVP | PPN | V | Other |

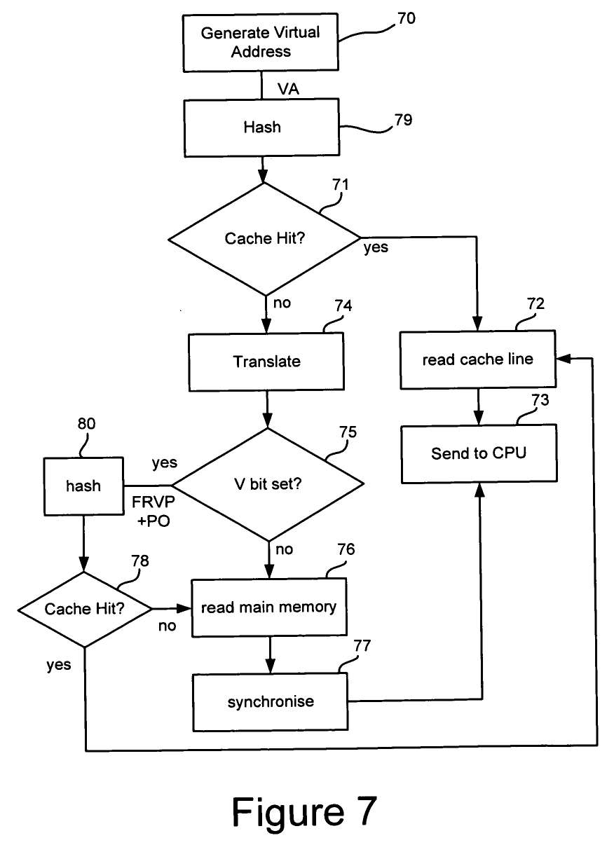

A flow diagram for the second method is shown in FIG. 7. The flow diagram is identical to FIG. 6, except step 80 where the FRVP and Page Offset are hashed at step 80, and the hashed address is input to the cache at step 78. If there is a cache hit, the process jumps to step 72. If not, the PPN stored in the PTE/TLB, and the Page Offset (from the virtual address of the alias) are used to read the main memory 5 in step 76.

It can be seen that this second method helps to avoid the overhead of additional translation, as translation step 74 will only be performed once.

A third method of updating the PTE/TLB (similar to the method of FIG. 5) is shown in the algorithm below. Instead of differentiating between master and slave aliases by means of the V bit in the PTE/TLB, this method designates slave aliases by enabling an access trap on access to these entries.

Algorithm for inserting translation (VPN, PPN)
begin

Check whether this virtual page (VPN) is an alias.
If its is an alias then FRVP = Retrieve FRVP
from through reverse lookup
using PPN
If it is an alias, then insert <VPN , FRVP > into
PTE(Page Table Entry)/TLB
Enable trap on access on these entries

end

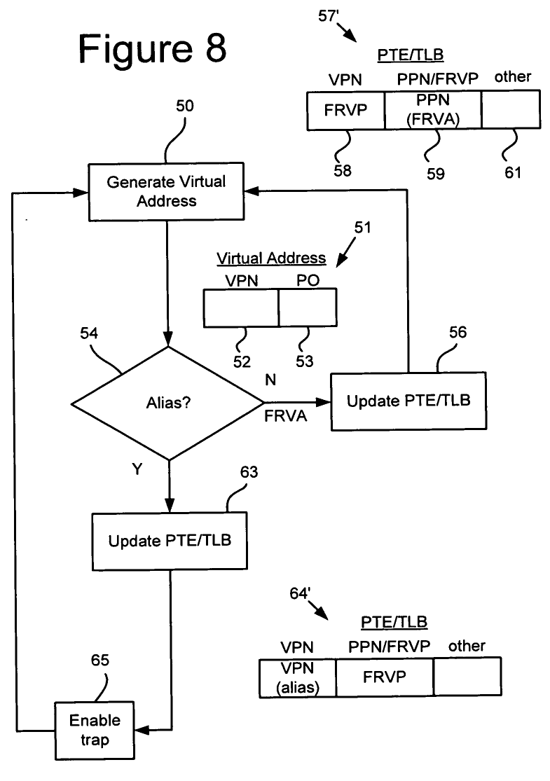

This algorithm is illustrated in FIG. 8. Elements common with the method illustrated in FIG. 5 are given the same reference numerals. The PTE/TLB entries 57′ and 64′ are similar to the entries 57 and 64 in FIG. 5, but it will be noted that there is no V-bit. Also, following step 63, a software trap is enabled for the alias in step 65.

An algorithm for handling the access trap when an alias (VA) is accessed is shown below. This Algorithm does not try to replace FRVP very often. It assumes that FRVP is the master alias which is being referenced more often than the other aliases. There will not be any access traps while accessing the memory using the virtual page FRVP. At the same time, every time memory is accessed through any of the aliases, an access trap is generated. This algorithm requires a supplementary algorithm to promote any of the aliases to FRVA. Examples of both algorithms are given below.

Algorithm trap_on_accessing_alias(VA)
Begin

VPN = VA/PAGE_SIZE
Get FRVP from TLB/Page Table corresponding to VPN
Lookup FRVP in TLB/Page Table for validity
If FRVP is a valid virtual address
Begin

Get the Load or Store instruction that got trapped while

accessing memory

Check source or destination register's contents to see which
one contains the address that got trapped.
Compute FRVA as FRVA = FRVP + (VA % PAGE_SIZE)
If (Contents of (source register) == VA)

Contents of source register = FRVA

Else If (Contents of (destination register) == VA)

Contents of destination register = FRVA

End

End

Suppose we have two aliases V1 and V2 that access the same physical page P. We designated V1 as FRVP as it was the first one to be accessed. As a result, the cache would contain the data corresponding to V1. Suppose the program accessed the address V1+16 and got data loaded into cache. Now the same program is trying to access the same memory through V2+16. It will experience a trap and as a result it will enter into the trap routine given above. It will find FRVP for the page V2 (in this case, the translation for V2 is V1). It will compute a new address as V1+16 (that is, V2+16 is translated to V1+16).

This mechanism always ensures only FRVAs are cached and can be accessed directly. Each slave alias needs to be interpreted to FRVA for access by the formula {Vk (k=1 . . . n)+<offset>}=>{V1+<offset>}.

If the current FRVP is no longer the most frequently referenced alias, it can be replaced with an alias that is being referenced more frequently. This requirement also arises when FRVP gets retired (either due to an owning process expiring or the owning process needing to release the memory).

Algorithm promote_as_FRVP(VP)
Begin

FRVP = Lookup in TLB/Page Table for VP
Old FRVP = FRVP
PPN = Lookup FRVP in TLB/Page Table
FRVP = VP
Validate and invalidate caches corresponding to Old FRVP
Insert <FRVP, PPN>
Replace All <???, Old FRVP> entries with <???, FRVP>

End

The essence of this solution is similar to the solution of FIGS. 5 and 6 with the primary difference being that V Bit is not understood by the CPU. This solution helps to differentiate master and slave translations, and accessing via the master yields better performance which is highly desirable when the master is accessed significantly more often than the other (slave) aliases. The master and slave may be set dynamically based on the access pattern.

The three methods according to the embodiments described above provide the following advantages:
1. Seamless support of aliases on systems that depend on virtually indexed caches. Cache coherency problems do not arise if aliases exist.
2. Provision of read only and read/write sharing of memory pages between processes on systems that use virtually indexed caches.
3. Provision of true support for copy-on-write scheme for system calls like fork on processors that rely on virtually indexed caches.
4. Unix mmap system call can support private mapping on virtually indexed caches.
5. IO memory aliases and hardware cache coherency

Although the technique has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of handling multiple aliases, the method comprising:
designating one of the aliases as a master alias; designating the other aliases as slave aliases; caching data associated with the master alias;
storing a translation for each slave alias; handling memory accesses for the master alias by using the master alias to access the cache; and
handling memory accesses for each slave alias by obtaining the stored translation and using the translation to access the cache.

2. A method according to claim 1 further comprising:
providing a master translation table entry associated with the master alias, the master translation table entry including a main memory location; and
providing a slave translation table entry associated with each slave alias, each slave translation table entry including the translation for the slave alias.

3. A method according to claim 2 wherein the master alias is designated by setting a V-bit in the master translation table entry to a first value; and each slave alias is designated by setting a V-bit in its respective slave translation table entry to a second value.

4. A method according to claim 3 wherein the master alias is designated by de-asserting the V-bit in the master translation table entry; and each slave alias is designated by asserting the V-bit in its respective slave translation table entry.

5. A method according to claim 1 wherein each stored translation comprises a virtual page number of the master alias.

6. A method according to claim 1 wherein each stored translation comprises a virtual page number of the master alias which is used to access the cache, and a main memory location which is used to access main memory in the event of a cache miss.

7. A method according to claim 1 wherein each slave alias is designated by enabling an access trap on access to the slave alias.

8. A method according to claim 1 further comprising:
promoting one of the slave aliases as a new master alias;
designating the master alias as an old master alias; caching data associated with the new master alias;
storing a translation for the old master alias;
handling memory accesses for the new master alias by using the new master alias to access the cache; and
handling memory accesses for the old master alias by obtaining the stored translation and using the translation to access the cache.

9. A method according to claim 8 wherein memory accesses for the new master alias are being performed more frequently than for the old master alias.

10. A method according to claim 1 wherein the method supports private mapping.

11. A method according to claim 1 comprising receiving a series of aliases, designating the first alias in the series as the master alias, and designating all subsequent aliases as slave aliases.

12. A computer system comprising a cache; and a processor configured to handle access to the cache by a method according to claim 1.

13. A method of updating a translation table, the method comprising:
providing a master translation table entry associated with a master alias, the master translation table entry including a main memory location;
providing a slave translation table entry associated with one or more slave alias, each slave translation table entry including a translation for the slave alias;
setting a V-bit in the master translation table entry to a first value; and
setting a V-bit in each slave translation table entry to a second value.

14. A method according to claim 13 comprising receiving a series of aliases, designating the first alias in the series as the master alias, and designating all subsequent aliases as slave aliases.

15. A method according to claim 13 wherein each slave translation table entry comprises a virtual page number of the master alias, and a main memory location.

16. A computer system comprising a translation table; and a processor configured to update the translation table by a method according to claim 13.

17. A method of updating a translation table, the method comprising:
providing a master translation table entry associated with a master alias, the master translation table entry including a main memory location;
providing a slave translation table entry associated with one or more slave alias, each slave translation table entry including a translation for the slave alias; and
enabling a software trap on access to each slave alias.

18. A method according to claim 17 comprising receiving a series of aliases, designating the first alias in the series as the master alias, and designating all subsequent aliases as slave aliases.

19. A computer system comprising a translation table; and a processor configured to update the translation table by a method according to claim 17.
